(19) United States
(12) Patent Application Publication
(10) Pub. No.: US 2022/0088542 A1
(43) Pub. Date: Mar. 24, 2022

(54) COMPOSITE HOLLOW FIBER MEMBRANE AND COMPOSITE HOLLOW FIBER MEMBRANE MANUFACTURING METHOD

(71) Applicant: Kuraray Co., Ltd., Kurashiki-shi (JP)

(72) Inventors: Kota MIHARA, Okayama (JP); Youhei YABUNO, Okayama (JP); Yoshito MIZUMOTO, Okayama (JP); Kensaku KOMATSU, Okayama (JP)

(73) Assignee: Kuraray Co., Ltd., Kurashiki-shi (JP)

(21) Appl. No.: 17/429,473

(22) PCT Filed: Feb. 17, 2020
(86) PCT No.: PCT/JP2020/005990

§ 371 Date: Aug. 9, 2021

(30) Foreign Application Priority Data
Feb. 28, 2019 (JP) 2019-036304

(51) Int. Cl. B01D 69/08; B01D 61/00; B01D 71/56; B01D 69/02; B01D 69/10; B01D 69/12

(52) U.S. Cl. CPC B01D 69/08; B01D 61/002; B01D 71/56; B01D 69/02; B01D 69/10; B01D 2323/46; B01D 2325/02; B01D 2325/04; B01D 2325/24; B01D 2323/30; B01D 69/12

(57) ABSTRACT

A composite hollow fiber membrane according to one aspect of the present invention is provided with a semipermeable membrane layer, a support layer that has a hollow fiber shape and is porous, and an intermediate layer interposed between the semipermeable membrane layer and the support layer. The semipermeable membrane layer contains a crosslinked polyamide formed of a polyfunctional amine compound and a polyfunctional acid halide compound. The intermediate layer includes a layer portion made of the same material as the support layer, and the crosslinked polyamide impregnating the layer portion.

### TECHNICAL FIELD

The present invention relates to a composite hollow fiber membrane and a method for manufacturing a composite hollow fiber membrane.

### BACKGROUND ART

Regarding the separation of liquid mixtures, there are various techniques for selectively separating substances dissolved in a solvent. For example, membrane separation methods such as a microfiltration method, an ultrafiltration method, a reverse osmosis method, and a forward osmosis method can be mentioned as an energy-saving and low-cost separation technique in comparison with a separation technique such as distillation. Among these membrane separation methods, development of a membrane separation method called a nanofiltration method, which is located between a reverse or forward osmosis method and an ultrafiltration method, is in progress. Such various membrane separation methods can not only separate the liquid mixture but also concentrate it by selecting an appropriate membrane separation method depending on the object to be removed or the like. The separation and concentration of the liquid mixture by such a membrane separation method is used in various fields because the membrane separation method does not involve a change of state of a substance. Specific examples thereof include fruit juice concentration and brewer's yeast separation in the food field, ultrapure water production in the semiconductor field, and desalination of brine such as seawater in the drinking water production field.

Among the membrane separation methods, for example, the nanofiltration method, the reverse osmosis method, the forward osmosis method, and the like are membrane separation methods using a semipermeable membrane. In the membrane separation method using a semipermeable membrane, for example, there is used a membrane provided with a semipermeable membrane layer having the function of a semipermeable membrane, such as a nanofiltration (NF) membrane, a reverse osmosis (RO) membrane, and a forward osmosis (FO) membrane. Examples of the membrane used in the membrane separation method using such a semipermeable membrane include not only a semipermeable membrane layer but also a composite membrane provided with a support layer for supporting the semipermeable membrane layer.

Examples of such a composite membrane include a forward osmosis membrane described in Patent Literature 1 and a composite hollow fiber membrane obtained by the manufacturing method described in Patent Literature 2.

Patent Literature 1 describes a forward osmosis membrane in which a thin film layer having semipermeable membrane performance is laminated on a polyketone support layer. According to Patent Literature 1, there is disclosed that a forward osmosis treatment system having sufficient durability against organic compounds and excellent water permeability can be provided by applying this forward osmosis membrane.

In Patent Literature 2, there is a statement of a method for manufacturing a composite hollow fiber membrane as follows: when a separation active layer made of a polymer thin film is formed on the outer surface of a porous hollow fiber membrane to form a composite, the porous hollow membrane is sequentially brought into contact with a first solution containing at least one polyfunctional compound A and a second solution containing at least one polyfunctional compound B and which is substantially immiscible with the first solution, the polymer thin film being formed through a reaction between the polyfunctional compound A and the polyfunctional compound B; then, the polyfunctional compounds A and B are subjected to interfacial polymerization with each other on the porous hollow fiber membrane to form a thin film; and after a continuous composite hollow fiber membrane is brought into contact with the first solution followed by the second solution, the composite hollow fiber membrane is brought into contact with a third solution which is substantially immiscible with the second solution, in at least one place. Patent Literature 2 discloses that a method for easily manufacturing a composite hollow fiber membrane having excellent permeation performance and separation performance can be provided.

The composite membrane includes an active layer such as a semipermeable membrane layer, and a support layer that supports the active layer. Since the active layer and the support layer are required to have different performances, they are formed of different materials. When a semipermeable membrane layer is used as the active layer in the composite membrane, the separation method using the composite membrane uses a semipermeable membrane layer that allows a solvent such as water to permeate more easily than a solute. That is, when a composite membrane having a semipermeable membrane layer and a support layer is used in the separation method, it is mainly the semipermeable membrane layer that contributes to the separation. Further, in the case of a composite membrane, since the semipermeable membrane layer is supported by the support layer, a thin semipermeable membrane layer is preferred for the purpose of improving water permeability and the like.

Examples of the technique for forming a thin active layer include a coating method, a plasma polymerization method, and an interfacial polymerization method. Among these methods, when the active layer is a semipermeable membrane layer, a thinner semipermeable membrane layer can be formed by the interfacial polymerization method and can exhibit higher permeation performance in comparison with the case where such a thinner semipermeable membrane layer is formed by another method. The interfacial polymerization method is a method for polymerizing two or more kinds of reactive compounds at an interface formed by dissolving each reactive compound in water and an organic solvent forming an interface and contacting the obtained solutions with each other. Specifically, as described in Patent Literature 1 and Patent Literature 2, there is mentioned a method of forming an active layer on a porous layer by applying an aqueous polyamine solution to one surface of a support layer such as a porous layer, followed by application of an organic solvent solution of a polycarboxylic acid derivative, a polyfunctional acid halogenide, or a polyfunctional isocyanate.

### CITATION LIST

### Patent Literature

Patent Literature 1: WO 2016/024573

Patent Literature 2: JP 8-66625 A

### SUMMARY OF INVENTION

An object of the present invention is to provide a composite hollow fiber membrane enabling separation to be suitably performed using a semipermeable membrane layer and having excellent durability, and a method for manufacturing the composite hollow fiber membrane.

One aspect of the present invention includes a composite hollow fiber membrane provided with a semipermeable membrane layer, a support layer that has a hollow fiber shape and is porous, and an intermediate layer interposed between the semipermeable membrane layer and the support layer, wherein the semipermeable membrane layer contains a crosslinked polyamide formed of a polyfunctional amine compound and a polyfunctional acid halide compound, and the intermediate layer includes a layer portion made of a same material as the support layer, and the crosslinked polyamide impregnating the layer portion.

### BRIEF DESCRIPTION OF DRAWINGS

FIG. 1 is a partial perspective view showing the composite hollow fiber membrane according to one embodiment of the present invention.

FIG. 2 is a schematic view showing one example of the layer structure of the composite hollow fiber membrane shown in FIG. 1.

FIG. 3 is a schematic view showing another example of the layer structure of the composite hollow fiber membrane shown in FIG. 1.

FIG. 4 is a scanning electron micrograph showing the vicinity of the outer peripheral surface in the cross section of the composite hollow fiber membrane according to Example 1.

FIG. 5 is a scanning electron micrograph showing the vicinity of the outer peripheral surface in the cross section of the composite hollow fiber membrane according to Comparative Example 1.

### DESCRIPTION OF EMBODIMENTS

It is considered that examples of the composite membrane having a semipermeable membrane layer and a support layer include a composite membrane having a support layer of a flat membrane, and a composite membrane having a support layer of a hollow fiber membrane, as described in Patent Literature 1. The composite membrane is generally used for water treatment as a module housed in a casing called a housing. For this reason, the present inventors focused on being able to provide a more space-saving water treatment system because the surface area of the membrane per module is increased by using a hollow fiber membrane instead of a flat membrane as the support layer provided in the composite membrane. That is, the present inventors focused on using not a flat membrane but a hollow fiber membrane that can make the membrane area per installation area larger than that of the flat membrane as the support layer provided in the composite membrane so that the separation using a semipermeable membrane layer is suitably performed.

However, according to the studies by the present inventors, there are cases where a composite hollow fiber membrane capable of suitably performing the separation by using a semipermeable membrane layer cannot be obtained simply by using the hollow fiber membrane as the support layer. In addition, there are cases where a composite hollow fiber membrane having sufficiently high durability cannot be obtained due to peeling occurring at the interface between the semipermeable membrane layer and the support layer.

The present inventors have focused, for example, on the fact that there are cases where a semipermeable membrane layer may not be suitably formed by bringing the hollow fiber membrane into contact with a roller or the like that conveys the hollow fiber membrane during or after polymerization for forming the semipermeable membrane layer on the hollow fiber membrane that is a support layer. In such a case, the obtained composite hollow fiber membrane cannot perform separation suitably with use of a semipermeable membrane layer. Further, according to the study by the present inventors, the durability of the obtained composite hollow fiber membrane is insufficient in some cases only by forming the semipermeable membrane layer on the hollow fiber membrane so that the hollow fiber membrane does not contact with the rollers or the like. For example, when a plurality of composite hollow fiber membranes are housed in a housing as a module used for water treatment, the semipermeable membranes provided in the composite hollow fiber membranes are sometimes damaged by the contact of the composite hollow fiber membranes with each other in the housing. Further, the semipermeable membrane layer provided in the composite hollow fiber membrane may be damaged by the shaking and bending of the composite hollow fiber membrane. As described above, the durability of the obtained composite hollow fiber membrane is insufficient in some cases. Further, when the semipermeable membrane layer is damaged in this way, separation by the semipermeable membrane layer cannot be suitably performed thereafter. The present inventors presumed that such damage to the semipermeable membrane layer is caused by the interface state between the support layer and the semipermeable membrane layer, and conducted various studies. As a result of these studies, it is found that the above objectives are achieved by the following invention providing a composite hollow fiber membrane that can perform separation suitably by a semipermeable membrane layer and has excellent durability, as well as providing a method for manufacturing the composite hollow fiber membrane.

Hereinafter, embodiments according to the present invention will be described, but the present invention is not limited thereto.

[Composite Hollow Fiber Membrane]

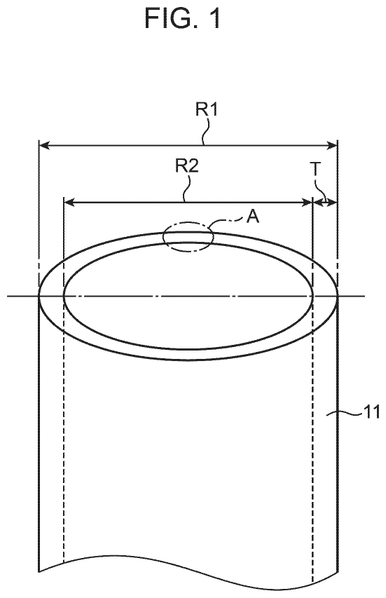

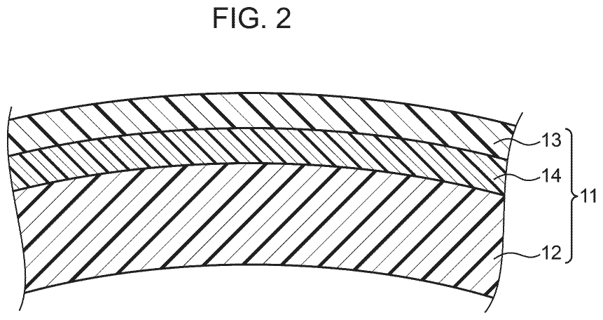

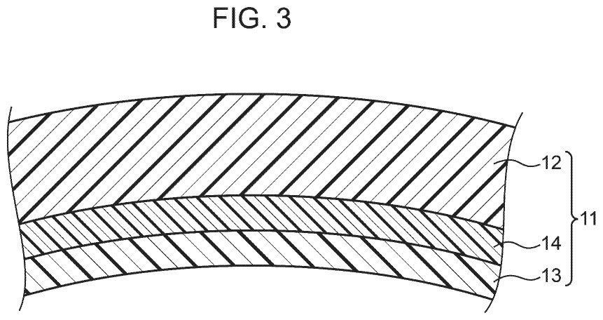

As shown in FIG. 1, a composite hollow fiber membrane 11 according to the embodiment of the present invention is a membrane that has a hollow fiber shape. Further, as shown in FIGS. 2 and 3, the composite hollow fiber membrane 11 includes a support layer 12 that has a hollow fiber shape and is porous, a semipermeable membrane layer 13, and an intermediate layer 14. The semipermeable membrane layer 13 contains a crosslinked polyamide formed of a polyfunctional amine compound and a polyfunctional acid halide compound, that is, a crosslinked polyamide formed by polymerizing a polyfunctional amine compound and a polyfunctional acid halide compound. The intermediate layer 14 includes a layer portion made of the same material as the support layer 12 and the crosslinked polyamide impregnating the layer portion.

The composite hollow fiber membrane 11 can perform separation more suitably by a semipermeable membrane layer and is also excellent in durability. This is considered to be due to the following.

First, since the composite hollow fiber membrane 11 is provided with the semipermeable membrane layer 13 containing a crosslinked polyamide formed of a polyfunctional amine compound and a polyfunctional acid halide compound on the support layer 12, it is considered that separation using the semipermeable membrane layer can be suitably performed. In addition, by using a support layer that has a hollow fiber shape as the support layer 12, the membrane area can be made wider than that in the case of a flat membrane. Further, the composite hollow fiber membrane 11 has the intermediate layer 14 between the semipermeable membrane layer 13 and the support layer 12, wherein the intermediate layer 14 includes a layer portion made of the same material as the support layer and the crosslinked polyamide impregnating the layer portion. It is considered that the intermediate layer 14 can prevent the semipermeable membrane layer 13 from peeling off front the support layer 12. Therefore, it is considered that the composite hollow fiber membrane 11 can suppress the occurrence of damage to the semipermeable membrane layer due to the shaking and bending of the composite hollow fiber membrane 11, the mutual contact between the composite hollow fiber membranes, and the like. Moreover, since the intermediate layer 14 contains the crosslinked polyamide constituting the semipermeable membrane layer 13, the same separation as the separation using a semipermeable membrane layer can be performed. From this, even if a part of the semipermeable membrane layer 13 is damaged, the same separation as the separation using a semipermeable membrane layer can be performed by the intermediate layer 14.

From the above, it is considered that the composite hollow fiber membrane 11 is a composite hollow fiber membrane that can perform separation suitably with a semipermeable membrane layer and has excellent durability.

When the composite hollow fiber membrane is used, for example, in the forward osmosis method, two solutions having different solute concentrations are brought into contact with each other via the composite hollow fiber membrane, and the osmotic pressure difference generated from the solute concentration difference is used as a driving force, so that water can be suitably permeated from a dilute solution having a low solute concentration to a concentrated solution having a high solute concentration. When the composite hollow fiber membrane is used in the forward osmosis method, such a membrane can exhibit, for example, excellent desalination performance.

Note that FIG. 1 is a partial perspective view showing the composite hollow fiber membrane 11 according to the embodiment of the present invention. Further, FIGS. 2 and 3 show a layer structure of the composite hollow fiber membrane 11 by enlarging a part A of the composite hollow fiber membrane 11 shown in FIG. 1. Note that FIGS. 2 and 3 are schematic views showing a positional relationship between layers and not particularly showing a relationship between the thicknesses of the layers.

The composite hollow fiber membrane 11 may be provided with the semipermeable membrane layer 13 in contact with the outer peripheral surface of the support layer 12 via the intermediate layer 14 as shown in FIG. 2, or may be provided in contact with the inner peripheral surface of the support layer 12 via the intermediate layer 14 as shown in FIG. 3. That is, as shown in FIG. 2, in the composite hollow fiber membrane 11, the intermediate layer 14 may be arranged in contact with the outer peripheral surface of the support layer 12, and the semipermeable membrane layer 13 may be arranged in contact with the outer peripheral surface of the intermediate layer 14, or as shown in FIG. 3, the intermediate layer 14 may be arranged in contact with the inner peripheral surface of the support layer 12, and the semipermeable membrane layer 13 may be arranged in contact with the inner peripheral surface of the intermediate layer 14. Among these, as shown in FIG. 2, in the composite hollow fiber membrane 11, it is preferable that the intermediate layer 14 is arranged in contact with the outer peripheral surface of the support layer 12, and the semipermeable membrane layer 13 is arranged in contact with the outer peripheral surface of the intermediate layer 14. Since the semipermeable membrane layer is arranged in contact with the outer peripheral surface of the support layer via the intermediate layer, the area of the semipermeable membrane layer can be more increased than the case where the semipermeable membrane layer is arranged in contact with the inner peripheral surface side of the support layer. Thus, it is considered that the composite hollow fiber membrane can perform separation more suitably using the semipermeable membrane layer. On the other hand, in general, in the composite hollow fiber membrane, when the semipermeable membrane layer is formed on the outer peripheral surface side of the support layer, as described above, the semipermeable membrane layer is prone to damage due to contact between the composite hollow fiber membranes. On the contrary, in the composite hollow fiber membrane according to the present embodiment, as described above, the occurrence of damages to the semipermeable membrane layer due to contact between the composite hollow fiber membranes can be suppressed, and further, an intermediate layer capable of performing the same separation as the separation using a semipermeable membrane layer is provided. In addition, it is easier to manufacture the semipermeable membrane layer and the intermediate layer on the outer peripheral surface side of the support layer. From these facts, it is considered that a composite hollow fiber membrane having excellent durability can be obtained even if the semipermeable membrane layer is formed on the outer peripheral surface side of the support layer. From these facts, it is preferable that the semipermeable membrane layer is formed on the outer peripheral surface side of the support layer.

(Semipermeable Membrane Layer)

The semipermeable membrane layer 13 contains a crosslinked polyamide formed of a polyfunctional amine compound and a polyfunctional acid halide compound, that is, the semipermeable membrane layer 13 is not particularly limited so long as the semipermeable membrane layer is a layer containing a crosslinked polyamide formed by polymerizing a polyfunctional amine compound and a polyfunctional acid halide compound and exhibiting a function as a semipermeable membrane. Such a crosslinked polyamide is a crosslinked polyamide obtained by polymerizing a polyfunctional amine compound and a polyfunctional acid halide compound, and may contain components other than the polyfunctional amine compound and the polyfunctional acid halide compound, the components being produced during the polymerization between the polyfunctional amine compound and the polyfunctional acid halide compound. The content of the crosslinked polyamide in the semipermeable membrane layer 13 is preferably 90 to 100% by mass, more preferably 100%. That is, the semipermeable membrane layer 13 is preferably made of only the crosslinked polyamide.

The polyfunctional amine compound is not particularly limited so long as it is a compound having two or more amino groups in the molecule. Examples of the polyfunctional amine compound include an aromatic polyfunctional amine compound, an aliphatic polyfunctional amine compound, and an alicyclic polyfunctional amine compound. Examples of the aromatic polyfunctional amine compound include phenylenediamines such as m-phenylenediamine, p-phenylenediamine, and o-phenylenediamine; triaminobenzenes such as 1,3,5-triaminobenzene and 1,3,4-triaminobenzene; diaminotolunes such as 2,4-diaminotoluene and 2,6-diaminotoluene; 3.5-diaminobenzoic acid; xylylenediamine; 2,4-diaminophenol dihydrochloride (amidol); and the like. Further, examples of the aliphatic polyfunctional amine compound include ethylenediamine, propylenediamine, and tris(2-aminoethyl)amine. Examples of the alicyclic polyfunctional amine compound include 1,3-diaminocyclohexane, 1,2-diaminocyclohexane, 1,4-diaminocyclohexane, piperazine, 2,5-dimethyl piperazine, and 4-aminomethylpiperazine. Among these, aromatic polyfunctional amine compounds are preferable, and phenylenediamine is more preferred. In addition, as the polyfunctional amine compound, the above-exemplified compounds may be used alone, or two or more kinds thereof may be used in combination.

The polyfunctional acid halide compound (polyfunctional acid halogenide) is not particularly limited so long as it is a compound formed by removing two or more hydroxyl groups from a polyfunctional organic acid compound having two or more acids such as carboxylic acid in the molecule and binding a halogen to the acid from which the hydroxy groups are removed. The polyfunctional acid halide compound may be difunctional or higher, and preferably trifunctional or higher. Examples of the polyfunctional acid halide compound include a polyfunctional acid fluoride, a polyfunctional acid chloride, a polyfunctional acid bromide, and a polyfunctional acid iodide. Among these, a polyfunctional acid chloride (polyfunctional acid chloride compound) is preferably used because it is most easily obtained and has high reactivity, but the polyfunctional acid halide compound is not limited to this. In addition, the polyfunctional acid chloride will be exemplified below, and examples of the polyfunctional acid halogenide other than the polyfunctional acid chloride include those in which the following-exemplified chloride is changed to another halogenide.

Examples of the polyfunctional acid chloride compound include an aromatic polyfunctional acid chloride compound, an aliphatic polyfunctional acid chloride compound, an alicyclic polyfunctional chloride compound, and the like. Examples of the aromatic polyfunctional acid chloride compound include trimesic acid trichloride, terephthalic acid dichloride, isophthalic acid dichloride, biphenyldicarboxylic acid dichloride, naphthalenedicarboxylic acid dichloride, benzenetrisulfonic acid trichloride, benzenedisulfonic acid dichloride, and the like. Further, examples of the aliphatic polyfunctional acid chloride compound include propanedicarboxylic acid dichloride, butanedicarboxylic acid dichloride, pentanedicarboxylic acid dichloride, propanetricarboxylic acid trichloride, butanetricarboxylic acid trichloride, pentanetricarboxylic acid trichloride, glutalyl chloride, adipoyl chloride, and the like. In addition, examples of the alicyclic polyfunctional chloride compound include cyclopropanetricarboxylic acid trichloride, cyclobutanetetracarboxylic acid tetrachloride, cyclopentanetricarboxylic acid trichloride, cyclopentanetetracarboxylic acid tetrachloride, cyclohexanetricarboxylic acid trichloride, and tetrahydrofurantetracarboxylic acid tetrachloride, cyclopentanedicarboxylic acid dichloride, cyclobutanedicarboxylic acid dichloride, cyclohexanedicarboxylic acid dichloride, tetrahydrofurandicarboxylic acid dichloride, and the like. Among these, aromatic polyfunctional acid chloride compounds are preferable and trimesic acid trichloride is more preferred. Further, as the polyfunctional acid halide compound, the above-exemplified compounds may be used alone, or two or more kinds thereof may be used in combination.

(Support Layer)

As described above, the support layer 12 is not particularly limited so long as it has a hollow fiber shape and is porous. Further, since the support layer 12 is porous, voids are formed inside the support layer, so that water can be permeated.

The average diameter of pores of the support layer 12 on the side where the semipermeable membrane layer 13 is formed is preferably 0.01 to 2 μm, more preferably 0.15 to 2 μm. If the average diameter is too large, the pores are large, so that there is a tendency that the intermediate layer cannot be suitably formed on the support layer or the semipermeable membrane layer cannot be suitably formed on the intermediate layer. That is, the support layer cannot be suitably covered with the semipermeable membrane layer, and separation by the semipermeable membrane layer tends to be difficult. When the composite hollow fiber membrane is used as, for example, a forward osmosis (FO) membrane, it tends to be difficult to obtain sufficient desalination performance. On the other hand, if the average diameter is too small, there is a tendency that separation by the semipermeable membrane layer cannot be suitably performed. This can be understood from Comparative Example 2 described later and considered to be due to the following. It is considered that the first solution does not sufficiently impregnate the hollow fiber member in the first contact step in the method for manufacturing a composite hollow fiber membrane described later. Therefore, even if the contact with the second solution is performed in the second contact step, the polymerization of the polyfunctional amine compound and the polyfunctional acid halide compound contained in each of the first solution and the second solution does not proceed sufficiently. Therefore, it is considered that there is a tendency such that the intermediate layer cannot be suitably formed on the support layer, or the semipermeable membrane layer cannot be suitably formed on the intermediate layer. From these facts, it is considered that the separation by the semipermeable membrane layer cannot be suitably performed. Therefore, when the average diameter is within the above range, the intermediate layer and the semipermeable membrane layer can be suitably formed, that is, the semipermeable membrane layer fixed firmly to the intermediate layer can be suitably formed, so that both separation and permeability by the semipermeable membrane layer can be achieved.

The average diameter refers to a particle diameter of the smallest particles that can block the passage through the support layer. Specifically, for example, the average diameter refers to a particle diameter when the ratio of Hocking permeation by the support layer (blocking rate by the support layer) is 90%. Specifically, the average diameter can be measured as follows.

The blocking rate of at least two types of particles with different particle diameters (CATALOID SI-550, CATALOID SI-45P, CATALOID SI-80P, manufactured by JGC Catalysts and Chemicals Ltd.; polystyrene latex having a particle diameter of 0.1 μm, 0.2 μm, or 0.5 μm, manufactured by Dow Chemical Company) was measured, and based on the measured value, the value of S at which R was 90 was determined in the following approximate formula, and this was used as the average diameter.

R=100/(1−m×exp(−a×log(S)))

In the above formula, a and m are constants determined by the hollow fiber membrane and are calculated based on the measured values of two or more blocking rates.

The support layer 12 may be made hydrophilic by containing a hydrophilic resin. The hydrophilic resin contained in the support layer 12 is preferably crosslinked. That is, it is preferable that the support layer 12 contains a crosslinked hydrophilic resin in a base material that has a hollow fiber shape and is porous. The crosslinked hydrophilic resin may be contained in the entire support layer 12 or in a part of the support layer 12, but in that case, it is preferable that the crosslinked hydrophilic resin is contained in the intermediate layer 14 side of the support layer 12, and it is more preferred that the crosslinked hydrophilic resin is contained in the intermediate layer 14 side of the support layer 12 and further contained in other portions.

The base material that has a hollow fiber shape and is porous is not particularly limited so long as it is a base material made of a material capable of forming a hollow fiber membrane. Examples of the components contained in the support layer 12 (components constituting the base material that has a hollow fiber shape) include acrylic resin, polyacrylonitrile, polystyrene, polyamide, polyacetal, polycarbonate, polyphenylene ether, polyphenylene sulfide, polyethylene terephthalate, polytetrafluoroethylene, polyvinylidene fluoride, polyetherimide, polyamideimide, polychloroethylene, polyethylene, polypropylene, polyketone, crystalline cellulose, polysulfone, polyphenylsulfone, polyethersulfone, acrylonitrile butadiene styrene (ABS) resin, acrylonitrile styrene (AS) resin, and the like. Of these, polyvinylidene fluoride, polysulfone, and polyethersulfone are preferable from the viewpoint of excellent pressure resistance. Further, as the component contained in the support layer 12 (component constituting the base material that has a hollow fiber shape), the above-exemplified resin may be used alone, or two or more kinds thereof may be used in combination.

The hydrophilic resin is not particularly limited so long as it is a resin capable of making the support layer 12 hydrophilic by being contained in the base material that has a hollow fiber shape and is porous. Examples of the hydrophilic resin include cellulose; cellulose acetate-based polymers such as cellulose acetate and cellulose triacetate; vinyl alcohol-based polymers such as polyvinyl alcohol and polyethylene vinyl alcohol; polyethylene glycol-based polymers such as polyethylene glycol and polyethylene oxide; acrylic acid-based polymers such as sodium polyacrylate; polyvinylpyrrolidone-based polymers such as polyvinylpyrrolidone; and the like. Among these, vinyl alcohol-based polymers and polyvinylpyrrolidone-based polymers are preferred, and polyvinyl alcohol and polyvinylpyrrolidone are more preferred. It is considered that polyvinyl alcohol and polyvinylpyrrolidone are more easily crosslinked and can further enhance the adhesiveness with a semipermeable membrane layer. That is, when at least one of polyvinyl alcohol and polyvinylpyrrolidone is used as a hydrophilic resin used for hydrophilizing the support layer, it is considered that these resins are easily crosslinked and are likely to impart appropriate hydrophilicity to the support layer. It is considered that the crosslinked hydrophilic resin is contained in the support layer, so that the adhesiveness with the semipermeable membrane layer containing the crosslinked polyamide polymer can be enhanced. From these facts, it is considered that the semipermeable membrane layer can be suitably formed on the dense surface of the support layer, and the formed semipermeable membrane layer is sufficiently suppressed from being peeled off from the support layer. From these facts, a composite hollow fiber membrane provided with the support layer containing these resins as a hydrophilic resin can perform separation more suitably by using a semipermeable membrane layer, and thus a composite hollow fiber membrane having more excellent durability can be provided. Further, as the hydrophilic resin, the above-exemplified resins may be used alone, or two or more kinds thereof may be used in combination. In addition, the hydrophilic resin may contain hydrophilic single molecules such as glycerin and ethylene glycol, or may be a polymer thereof, or may contain these as a copolymer component of the resin.

The crosslinking of the hydrophilic resin is not particularly limited so long as the hydrophilic resin is crosslinked and the solubility of the hydrophilic resin in water is reduced, and examples thereof include the crosslinking of insolubilizing the hydrophilic resin to prevent the hydrophilic resin from dissolving in water. When polyvinyl alcohol is used as the hydrophilic resin, examples of the crosslinking of the hydrophilic resin include an acetalization reaction using formaldehyde and an acetalization reaction using glutaraldehyde. Examples of the crosslinking of the hydrophilic resin when polyvinyl pyrrolidone is used as the hydrophilic resin include the reaction with hydrogen peroxide solution. It is conceivable that, for the crosslinking of the hydrophilic resin, when the degree of crosslinking of the hydrophilic resin is high, elution of the hydrophilic resin from the composite hollow fiber membrane can be suppressed even if the composite hollow fiber membrane is used for a long time. Thus, it is conceivable that peeling and the like between the semipermeable membrane layer and the support layer can be suppressed for a long time.

The support layer 12 preferably has an inclined structure in which pores of the support layer 12 gradually increase from one side of the inner surface and the outer surface toward the other side. The semipermeable membrane layer 13 is preferably formed on the dense surface side, which is the surface on the side where the pores of the support layer 12 are small. When the semipermeable membrane layer 13 is formed on the outer peripheral surface side of the support layer 12, as shown in FIG. 2, the support layer 12 preferably has an inclined structure in which the pores of the support layer 12 gradually increase from the outer surface toward the inner peripheral surface, that is, an inclined structure in which the pores of the support layer 12 gradually decrease from the inner surface toward the outer surface. The inclined structure in which the pores of the support layer 12 gradually increase from the outer surface toward the inner peripheral surface means a structure in which the pores existing on the outer surface are smaller than the pores existing on the inner peripheral surface, and the internal pores in size of the support layer 12 are equal to or greater than the pores existing on the outer peripheral surface and are equal to or less than the pores existing on the inner peripheral surface.

The support layer preferably has a Young's modulus of 50 to 300 N/mm². If the Young's modulus is too low, the durability of the composite hollow fiber membrane tends to be insufficient in practical operation using the composite hollow fiber membrane. The higher the Young's modulus is, the more it is preferable, but the Young's modulus that is too high may be unnecessary in practice. Note that the Young's modulus can be measured by a method in accordance with JIS K 7161-1.

The method for manufacturing the support layer 12 is not particularly limited so long as the hollow fiber membrane having the above configuration can be manufactured. Examples of the method for manufacturing the hollow fiber membrane include a method for manufacturing a porous hollow fiber membrane. As a method for manufacturing such a porous hollow fiber membrane, a method using phase separation is known. Examples of the method for manufacturing a hollow fiber membrane utilizing this phase separation include a nonsolvent induced phase separation method (NIPS method) and a thermally induced phase separation method (TIPS method).

The NIPS method is a method in which phase separation phenomenon is generated by contacting a uniform polymer stock solution obtained by dissolving a polymer in a solvent with a non-solvent in which the polymer cannot be dissolved to replace the solvent of the polymer stock solution with the non-solvent by the difference in concentration between the polymer stock solution and the non-solvent as the driving force. In the NIPS method, the pore diameter of the pores formed generally changes depending on the solvent replacement rate. Specifically, there is a tendency that the lower the solvent replacement rate is, the coarser the pores become. In the manufacturing of a hollow fiber membrane, the solvent replacement rate is the highest on the contact surface with the non-solvent and becomes lower toward the inside of the membrane. Thus, the hollow fiber membrane manufactured by the NIPS method has an asymmetric structure in which the vicinity of the contact surface with the non-solvent is dense and the pores are gradually coarsened toward the inside of the membrane.

The TIPS method is a method in which phase separation phenomenon is generated by dissolving at a high temperature a polymer in a poor solvent in which the polymer can be dissolved at a high temperature, but the polymer cannot be dissolved at a lower temperature and cooling the solution. Since the heat exchange rate is generally faster than the solvent replacement rate in the NIPS method, it is difficult to control the rate. Thus, in the TIPS method, uniform pores tend to be formed in the membrane thickness direction.

The method for manufacturing the hollow fiber membrane (the support layer) is not particularly limited so long as the hollow fiber membrane can be manufactured. Specific examples of such a manufacturing method include the following manufacturing methods. Examples of the manufacturing method include a method including a step of preparing a membrane-forming stock solution containing a resin and a solvent that constitute a hollow fiber membrane (preparation step), a step of extruding the membrane-forming stock solution to form a hollow fiber shape (extrusion step), and a step of coagulating the extruded membrane-forming stock solution that has a hollow fiber shape to form a hollow fiber membrane (formation step).

(Intermediate Layer)

As described above, the intermediate layer 14 is a layer interposed between the semipermeable membrane layer 13 and the support layer 12 and containing a layer portion made of the same material as the support layer 12 and the crosslinked polyamide contained in the semipermeable membrane layer 13, the crosslinked polyamide having impregnated the layer portion. That is, in the intermediate layer 14, when the semipermeable membrane layer 13 is formed on a hollow fiber member that is porous, the components constituting the semipermeable membrane layer 13 are a portion formed also in the hollow fiber member. In the hollow fiber member, a portion close to the surface thereof becomes the intermediate layer 14, and the other remaining portion serves as the support layer 12. Therefore, the layer portion of the intermediate layer 14 is made of the same material as the support layer 12. Further, the crosslinked polyamide impregnating the layer portion is made of the same material as the crosslinked polyamide contained in the semipermeable membrane layer 13. The intermediate layer is preferably formed continuously with the semipermeable membrane layer. As a result, the presence of the intermediate layer makes it difficult for the semipermeable membrane layer to be peeled off from the support layer. Further, the semipermeable membrane layer usually has a pleated structure, but it is preferable that the semipermeable membrane layer is formed continuously with the intermediate layer not only at the foot portion of the mountain portion of the fold but also at the valley portion.

The average diameter of pores on the surface of the semipermeable membrane layer side of the layer portion provided on the intermediate layer is substantially the same as the average diameter of pores of the support layer 12 on the side where the semipermeable membrane layer 13 is formed, preferably 0.01 to 2 μm, more preferably 0.15 to 2 μm, because the intermediate layer is very thin.

(Composite Hollow Fiber Membrane)

The outer diameter R1 of the composite hollow fiber membrane is preferably 0.1 to 2 mm, more preferably 0.2 to 1.5 mm, and still more preferably 0.3 to 1.5 mm. When the outer diameter is too small, the inner diameter of the composite hollow fiber membrane may also be too small. In this case, the liquid passing resistance at the hollow portion becomes large, and there is a tendency that a sufficient flow rate cannot not be obtained. Thus, when the composite hollow fiber membrane is used as a forward osmosis membrane or the like, the draw solution tends to be unable to flow at a sufficient flow rate. In addition, when the outer diameter is too small, the pressure resistance to the pressure applied from the outside tends to decrease. Further, when the outer diameter is too small, the membrane thickness of the composite hollow fiber membrane may be too small, and in this case, the strength of the composite hollow fiber membrane tends to be insufficient. That is, there is a tendency that a suitable pressure resistance cannot not be achieved. In the case of too large outer diameter, when a hollow fiber membrane module in which a plurality of composite hollow fiber membranes is placed in a housing is formed, the number of hollow fiber membranes placed in the housing decreases, the membrane area of hollow fiber membranes decreases, and the hollow fiber membrane module tends to be unable to have sufficient flow rate in practical use. When the outer diameter is too large, the pressure resistance to the pressure applied from the inside tends to decrease. Thus, when the outer diameter of the composite hollow fiber membrane is within the above-mentioned range, the composite hollow fiber membrane has sufficient strength and excellent permeability and can suitably perform separation by a semipermeable membrane.

The inner diameter R2 of the composite hollow fiber membrane is preferably 0.05 to 1.5 mm, more preferably 0.1 to 1 mm, and still more preferably 0.2 to 1 mm. When the inner diameter is too small, the liquid passing resistance at the hollow portion becomes large, and a sufficient flow rate tends to be unable to be obtained. When the composite hollow fiber membrane is used as a forward osmosis membrane or the like, the draw solution tends to be unable to flow at a sufficient flow rate. In addition, when the inner diameter is too small, the outer diameter of the composite hollow fiber membrane may also be too small. In this case, the pressure resistance to the pressure applied to the outside tends to decrease. Further, when the inner diameter is too large, the outer diameter of the composite hollow fiber membrane may be too large. In this case, when a hollow fiber membrane module in which a plurality of composite hollow fiber membranes is placed in a housing is formed, the number of hollow fiber membranes placed in the housing decreases, the membrane area of hollow fiber membranes decreases, and the hollow fiber membrane module tends to be unable to have sufficient flow rate in practical use. When the inner diameter is too large, the outer diameter of the composite hollow fiber membrane may also be too large. In this case, the pressure resistance to the pressure applied from the inside tends to decrease. When the inner diameter is too large, the membrane thickness of the composite hollow fiber membrane may be too small, and in this case, the strength of the composite hollow fiber membrane tends to be insufficient. That is, a suitable pressure resistance tends to be unable to be achieved. Thus, when the inner diameter of the composite hollow fiber membrane is within the above-mentioned range, the composite hollow fiber membrane has sufficient strength and excellent permeability and can suitably perform separation by a semipermeable membrane.

The membrane thickness T of the composite hollow fiber membrane is preferably 0.02 to 0.3 mm, more preferably 0.05 to 0.3 mm, and still more preferably 0.05 to 0.25 mm. When the membrane thickness is too small, the strength of the composite hollow fiber membrane tends to be insufficient. That is, there is a tendency that a suitable pressure resistance cannot be achieved. When the membrane thickness is too large, the permeability tends to decrease. When the membrane thickness is too large, internal concentration polarization in the support layer is likely to occur, so that the separation by a semipermeable membrane tends to be impaired. That is, when the composite hollow fiber membrane is used as a forward osmosis membrane or the like, the contact resistance between the draw solution and the feed solution increases, so that permeability tends to decrease. Thus, when the membrane thickness of the composite hollow fiber membrane is within the above-mentioned range, the composite hollow fiber membrane has sufficient strength and excellent permeability and can also suitably perform separation by a semipermeable membrane.

The membrane thickness of the semipermeable membrane layer 13 is the thickness of a portion formed by the following interfacial polymerization and formed on the surface of the following hollow fiber member. Specifically, the membrane thickness of the semipermeable membrane layer is 1 to 10000 nm, more preferably 1 to 5000 nm, and still more preferably 1 to 3000 run. If the membrane thickness is too thin, separation by the semipermeable membrane layer tends to be unable to be suitably performed. When the composite hollow fiber membrane is used as a forward osmosis membrane or the like, sufficient desalination performance cannot be exhibited, and separation by a semipermeable membrane layer cannot be suitably performed because the salt backflow rate increases. It is conceivable that this is because the semipermeable membrane layer is too thin to sufficiently perform the function of the semipermeable membrane layer, or the semipermeable membrane layer cannot sufficiently cover the support layer. Further, if the membrane thickness is too thick, the permeability tends to decrease. It is considered that this is because the semipermeable membrane layer is too thick and the water permeation resistance becomes large, so that it becomes difficult for water to permeate. Since the semipermeable membrane layer has a fold shape as described above, the distance between the ridge portion of the fold and the surface layer of the intermediate layer can be served as the thickness of the semipermeable membrane layer. For example, the thickness is an average value obtained by observing any three points on the cross section of the composite hollow fiber membrane by SEM and measuring the distance from the apex of the mountain of the fold to the surface of the support layer.

The membrane thickness of the intermediate layer 14 is the thickness of a portion formed by the following interfacial polymerization and formed in the following hollow fiber member (depth from the surface of the following hollow fiber member). This thickness is preferably 20 to 5000 nm, more preferably 50 to 1000 nm, and still more preferably 100 to 1000 nm. If the intermediate layer is too thin, the effect of the intermediate layer tends to be insufficiently exhibited. That is, there is a tendency that the semipermeable membrane layer cannot be sufficiently suppressed from being peeled off from the support layer. Further, if the intermediate layer is too thick, the permeability tends to decrease. It is considered that this is because the intermediate layer is too thick and the water permeation resistance becomes large, so that it becomes difficult for water to permeate. Therefore, when the membrane thickness of the intermediate layer is within the above range, it is possible to sufficiently suppress the semipermeable membrane layer from peeling off from the support layer, that is, to suitably perform separation by the semipermeable membrane layer, and those having excellent water permeability can be obtained.

The membrane thickness of the support layer 12 is a difference obtained by subtracting the membrane thickness of the semipermeable membrane layer 13 and the membrane thickness of the intermediate layer 14 from the membrane thickness of the composite hollow fiber membrane. Specifically, the membrane thickness of the support layer 12 is 0.02 to 0.3 mm, more preferably 0.05 to 0.3 mm, and still more preferably 0.05 to 0.25 mm. The membrane thickness of the support layer is almost the same as the membrane thickness of the composite hollow fiber membrane because the semipermeable membrane layer and the intermediate layer are much thinner than the support layer. When the membrane thickness is too small, the strength of the composite hollow fiber membrane tends to be insufficient. That is, there is a tendency that a suitable pressure resistance cannot be achieved. When the membrane thickness is too large, the permeability tends to decrease. Further, when the membrane thickness is too large, internal concentration polarization in the support layer is likely to occur, and the separation by a semipermeable membrane tends to be impaired. That is, when the composite hollow fiber membrane is used as a forward osmosis membrane or the like, the contact resistance between the draw solution and the feed solution increases, and thus permeability tends to decrease. Thus, when the membrane thickness of the composite hollow fiber membrane is within the above-mentioned range, the composite hollow fiber membrane has sufficient strength and excellent permeability and can also suitably perform separation by a semipermeable membrane.

The composite hollow fiber membrane can be applied to the membrane separation technique in which a semipermeable membrane is used. That is, the composite hollow fiber membrane can be used as, for example, an NF membrane, an RO membrane, and an FO membrane. Among them, the composite hollow fiber membrane is preferably an FO membrane used in the FO method.

[Method for Manufacturing Composite Hollow Fiber Membrane]

The method for manufacturing the composite hollow fiber membrane according to the present embodiment is not particularly limited so long as the above-mentioned composite hollow fiber membrane can be manufactured. Examples of the manufacturing method include a manufacturing method as described below. The manufacturing method include: a step of preparing a first solution containing one of the polyfunctional amine compound and the polyfunctional acid halide compound and a second solution containing the other of the polyfunctional amine compound and the polyfunctional acid halide compound (preparation step), a step of contacting the first solution with at least one surface side of the hollow fiber member that is porous (first contact step), and a step of further contacting the second solution with the surface side of the hollow fiber member in contact with the first solution while shaking the hollow fiber member (second contact step).

In the preparation step, the first solution and the second solution are prepared. That is, a solution containing the polyfunctional amine compound and a solution containing the polyfunctional acid halide compound are prepared.

Specific examples of the solution containing the polyfunctional amine compound include an aqueous solution of the polyfunctional amine compound. The aqueous solution of the polyfunctional amine compound preferably has a concentration of the polyfunctional amine compound of 0.1 to 10% by mass, more preferably 0.1 to 5% by mass. If the concentration of the polyfunctional amine compound is too low, a suitable semipermeable membrane layer tends not to be formed because of pinholes being formed in the formed semipermeable membrane layer. Therefore, the separation by the semipermeable membrane layer tends to be insufficient. Further, if the concentration of the polyfunctional amine compound is too high, the semipermeable membrane layer tends to be too thick. If the semipermeable membrane layer becomes too thick, the permeability of the obtained composite hollow fiber membrane tends to decrease. The aqueous solution of the polyfunctional amine compound is a solution in which the polyfunctional amine compound is dissolved in water, and additives such as salts, surfactants, and polymers may be added as needed.

Specific examples of the solution containing the polyfunctional acid halide compound include an organic solvent solution of the polyfunctional acid halide compound. The organic solvent solution of the polyfunctional acid halide compound preferably has a concentration of the polyfunctional acid halide compound of 0.01 to 5% by mass, more preferably 0.01 to 3% by mass. If the concentration of the polyfunctional acid halide compound is too low, a suitable semipermeable membrane layer tends not to be formed because of pinholes being formed in the formed semipermeable membrane layer. Therefore, separation by a semipermeable membrane layer, for example, the desalination performance tends to be insufficient. Further, if the concentration of the polyfunctional acid halide compound is too high, the semipermeable membrane layer tends to become too thick. If the semipermeable membrane layer becomes too thick, the permeability of the obtained composite hollow fiber membrane tends to decrease.

The organic solvent solution of the polyfunctional acid halide compound is a solution in which the polyfunctional acid halide compound is dissolved in an organic solvent. The organic solvent is not particularly limited so long as it is a solvent which dissolves the polyfunctional acid halide compound and is insoluble in water. Examples of the organic solvent include alkane-based saturated hydrocarbons such as n-hexane, cyclohexane, heptane, octane, nonane, decane, and dodecane. As the organic solvent, the above-exemplified solvents may be used alone, or two or more kinds thereof may be used in combination. Examples of the organic solvent include n-hexane and the like when used alone, and examples thereof include a mixed solvent of nonane, decane, and dodecane when used in combination of two or more kinds thereof. Additives such as salts, surfactants, and polymers may be added to the organic solvent, if necessary.

In the first contact step, the first solution is brought into contact with at least one surface side of the hollow fiber member that is porous. Specifically, in the first contact step, a solution containing the polyfunctional amine compound or a solution containing the polyfunctional acid halide compound is brought into contact with at least one surface side of the hollow fiber member. In the first contact step, it is preferable that a solution containing the polyfunctional amine compound is brought into contact with at least one surface side of the hollow fiber member. Thereby, the first solution permeates from one surface side of the hollow fiber member.

In the second contact step, the second solution is further brought into contact with the surface side of the hollow fiber member that has been brought into contact with the first solution. Specifically, in the second contact step, out of a solution containing the polyfunctional amine compound and a solution containing the polyfunctional acid halide compound, the solution not used in the first contact step is brought into contact with the surface side of the hollow fiber member in contact with the first solution. In the second contact step, when a solution containing the polyfunctional amine compound is used as the first solution, the solution containing the polyfunctional acid halide compound is brought into contact with the surface side of the hollow fiber member in contact with the first solution. Thereby, an interface is formed between the first solution impregnating the hollow fiber member in the first contact step and the second solution impregnating the hollow fiber member in the second contact step. Then, at the interface, the reaction between the polyfunctional amine compound and the polyfunctional acid halide compound contained in the first solution and the second solution proceeds. That is, interfacial polymerization of the polyfunctional amine compound and the polyfunctional acid halide compound occurs. A crosslinked polyamide is formed by this interfacial polymerization.

In the second contact step, when the second solution is brought into contact with the hollow fiber member, the hollow fiber member is shaken. That is, in the second contact step, the second solution is brought into contact with the surface side of the hollow fiber member that has been brought into contact with the first solution while shaking the hollow fiber member. When the hollow fiber member is shaken in this way, not only the crosslinked polyamide is formed on the surface of the hollow fiber member, but also the crosslinked polyamide is formed in a state of being impregnated from the surface of the hollow fiber member toward the inside. It is considered that this is because the interface is formed at a position inside from the surface of the hollow fiber member. Thus, the crosslinked polyamide formed on the surface of the hollow fiber member becomes the semipermeable membrane layer. Then, the region where the formed crosslinked polyamide impregnates from the surface of the hollow fiber member toward the inside becomes the intermediate layer. Further, in the hollow fiber member, the region where the crosslinked polyamide is not impregnated becomes the support layer. Note that the hollow fiber member is a hollow fiber membrane made of the same material as the support layer.

The manufacturing method may include a step (drying step) of drying the hollow fiber member which has been brought into contact with the first solution and the second solution. The drying step dries the hollow fiber member which has been brought into contact with the first solution and the second solution. In the second contact step, as described above, a crosslinked polyamide obtained by interfacial polymerization by contact between a solution containing the polyfunctional amine compound and a solution containing the polyfunctional acid halide compound is formed. By drying the hollow fiber member, the formed crosslinked polyamide is dried.

In the drying, the temperature and the like are not particularly limited so long as the formed crosslinked polyamide polymer is dried. The drying temperature is preferably, for example, 50 to 150° C., and preferably 80 to 130° C. When the drying temperature is too low, not only the drying tends to be insufficient, but also drying time becomes too long, so that production efficiency tends to decrease. When the drying temperature is too high, the formed semipermeable membrane layer is thermally degraded, and the separation by a semipermeable membrane tends not to be suitably performed. For example, desalination performance tends to decrease, or water permeability tends to decrease. The drying time is preferably, for example, 1 to 30 minutes, and more preferably 1 to 20 minutes. When the drying time is too short, the drying tends to be insufficient. When the drying time is too long, the production efficiency tends to decrease. The formed semipermeable membrane layer is thermally degraded, and the separation by a semipermeable membrane also tends not to be suitably performed. For example, desalination performance tends to decrease and water permeability tends to decrease.

According to the manufacturing method as described above, a composite hollow fiber membrane that can suitably perform the separation by a semipermeable membrane layer and further has excellent durability can be suitably manufactured.

It is preferable to further include, after the first contact step and before the second contact step, a step of removing the first solution existing on the surface of the hollow fiber member in contact with the first solution (removing step) in the manufacturing method.

The removing step is performed, after the first contact step and before the second contact step, to remove the first solution remaining on the surface of the hollow fiber member which is not impregnated into the hollow fiber member. That is, the liquid is drained after the first contact step and before the second contact step. The method of draining the liquid is not particularly limited, and examples thereof include an air blow that injects from a slit or a nozzle, such as an air knife. Examples of the gas to be injected include air, nitrogen, an inert gas, and the like.

In the manufacturing method, after the first contact step, a step of removing the first solution existing on the surface of the hollow fiber member in contact with the first solution is performed, and then the second contact step is performed. Thereby, it is considered that the interface on which the crosslinked polyamide is polymerized is more suitably formed inside from the surface of the hollow fiber member in contact with the first solution. From this, it is considered that the intermediate layer is more suitably formed. Therefore, it is considered that separation by the semipermeable membrane layer can be suitably performed, and further, a composite hollow fiber membrane having excellent durability can be more suitably manufactured. From the above, it is possible to suitably perform the separation by using a semipermeable membrane layer and further to manufacture a composite hollow fiber membrane having excellent durability more suitably.

In the manufacturing method, the second contact step is preferably a step in which the hollow fiber member contacts only the second solution. That is, in the second contact step, it is preferable that the hollow fiber member does not contact, for example, a roller that conveys the hollow fiber member, a container that holds the second solution, or the like, other than the second solution. In the second contact step, when the hollow fiber member contacts, for example, a roller that conveys the hollow fiber member, a container that holds the second solution, or the like other than the second solution, the semipermeable membrane layer may not be suitably formed. On the other hand, in the second contact step, when the hollow fiber member contacts only the second solution, such a risk does not occur, and separation by the semipermeable membrane layer can be suitably performed. Further, a composite hollow fiber membrane having excellent durability can be manufactured more suitably. In the second contact step, examples of the step in which the hollow fiber member contacts only the second solution include, for example, a method of spraying the second solution onto the hollow fiber member (first method), and a method of bringing the hollow fiber member into contact with the second solution held in a container or the like so that the hollow fiber member does not contact the container holding the second solution or the like (second method). Examples of the first method include a method in which the second solution is made into a mist and sprayed onto the hollow fiber member, a method in which the second solution is brought into contact with the hollow fiber member from above the hollow fiber member using a shower, and the like. Further, examples of the second method include, for example, a method of bringing the hollow fiber member into contact with a raised portion of the second solution formed by the surface tension of the second solution held in the container or the like, a method of bringing the hollow fiber member into contact with a raised portion of the second solution formed by the flow of the second solution held in the container (for example, the flow from the lower part to the upper part in the container), a method of bringing the hollow fiber member into contact with the second solution overflowing from the container, and the like.

In the manufacturing method, the composite hollow fiber membrane may be manufactured by a batch method or a continuous method, but from the viewpoint of mass production, it is preferable to manufacture the composite hollow fiber membrane by a continuous method.

As described above, the present specification discloses various modes of technique, of which the main techniques are summarized below.

One aspect of the present invention is a composite hollow fiber membrane characterized by including a semipermeable membrane layer, a support layer that has a hollow fiber shape and is porous, and an intermediate layer interposed between the semipermeable membrane layer and the support layer, wherein the semipermeable membrane layer contains a crosslinked polyamide formed of a polyfunctional amine compound and a polyfunctional acid halide compound, and the intermediate layer includes a layer portion made of a same material as the support layer and the crosslinked polyamide impregnating the layer portion.

According to such a configuration, separation by a semipermeable membrane layer can be suitably performed, and a composite hollow fiber membrane having excellent durability can be provided. This is considered due to the following.

First, since the composite hollow fiber membrane is provided with a semipermeable membrane layer containing a crosslinked polyamide formed of a polyfunctional amine compound and a polyfunctional acid halide compound on a support layer, it is considered that separation using the semipermeable membrane layer can be suitably performed. Further, by using a support layer that has a hollow fiber shape as the support layer, the membrane area can be made wider than that in the case of making a flat membrane. Further, the composite hollow fiber membrane has an intermediate layer between the semipermeable membrane layer and the support layer, wherein the intermediate layer includes a layer portion made of the same material as the support layer and the crosslinked polyamide impregnating the layer portion. It is considered that such an intermediate layer can prevent the semipermeable membrane layer from peeling off from the support layer. That is, it is considered that this intermediate layer exerts an anchor effect of suppressing the peeling of the semipermeable membrane layer from the support layer. Thus, it is considered that the composite hollow fiber membrane can suppress the occurrence of damages to the semipermeable membrane layer due to the shaking and bending of the composite hollow fiber membrane, contact between the composite hollow fiber membranes, and the like. Further, since this intermediate layer contains the crosslinked polyamide constituting the semipermeable membrane layer, the same separation as the separation using the semipermeable membrane layer can be performed. From this, even if a part of the semipermeable membrane layer is damaged, the same separation as the separation using the semipermeable membrane layer can be performed due to the presence of the intermediate layer.

From the above, it is considered that separation by a semipermeable membrane layer can be suitably performed, and a composite hollow fiber membrane having excellent durability can be obtained. Further, when the composite hollow fiber membrane is used, for example, in the forward osmosis method, two solutions having different solute concentrations are brought into contact with each other via the composite hollow fiber membrane, thereby to use, as a driving force, a difference in osmotic pressure caused by the difference in solute concentration. As a result, water can be suitably permeated from a dilute solution having a low solute concentration to a concentrated solution having a high solute concentration. When the composite hollow fiber membrane is used in the forward osmosis method, such a membrane can exhibit, for example, excellent desalination performance.

Further, in the composite hollow fiber membrane, a thickness of the intermediate layer is preferably 20 to 5000 nm.

According to such a configuration, a composite hollow fiber membrane having more excellent durability and capable of more suitably performing separation by a semipermeable membrane layer can be obtained.

Further, in the composite hollow fiber membrane, a Young's modulus of the composite hollow fiber membrane is preferably 50 to 300 N/mm².

According to such a configuration, a composite hollow fiber membrane having more excellent durability and capable of more suitably performing separation by a semipermeable membrane layer can be obtained.

Further, in the composite hollow fiber membrane, it is preferable that the intermediate layer is arranged in contact with an outer peripheral surface of the support layer and the semipermeable membrane layer is arranged in contact with the outer peripheral surface of the intermediate layer.

According to such a configuration, a composite hollow fiber membrane capable of more suitably performing separation by a semipermeable membrane layer can be obtained. This is considered due to the following.

Since the semipermeable membrane layer is in contact with the outer peripheral surface of the support layer via the intermediate layer, the area of the semipermeable membrane layer can be increased as compared with the case where the semipermeable membrane layer is in contact with the inner peripheral surface side of the support layer. From this, the area of the composite hollow fiber membrane, particularly the area of the semipermeable membrane layer can be increased. Therefore, it is considered that the composite hollow fiber membrane can perform separation more suitably by using a semipermeable membrane layer.

On the other hand, in general, in a composite hollow fiber membrane, when a semipermeable membrane layer is formed on the outer peripheral surface side of a support layer, the semipermeable membrane layer is prone to damage due to contact between the composite hollow fiber membranes as described above. Meanwhile, in the composite hollow fiber membrane according to one aspect of the present invention, as described above, the occurrence of damages to the semipermeable membrane layer due to contact between the composite hollow fiber membranes can be suppressed, and further, an intermediate layer capable of performing the same separation as the separation using the semipermeable membrane layer is provided. That is, the composite hollow fiber membrane is a composite hollow fiber membrane that has excellent durability and is capable of suitably performing separation by a semipermeable membrane layer. From this, it is considered that a composite hollow fiber membrane having excellent durability can be obtained even if the semipermeable membrane layer is formed on the outer peripheral surface side of the support layer.

From the above, it is considered that a composite hollow fiber membrane capable of more suitably performing separation by a semipermeable membrane layer can be obtained.

Further, in the composite hollow fiber membrane, an average diameter of pores on a surface of the semipermeable membrane layer side of the layer portion provided on the intermediate layer is preferably 0.01 to 2 μm.

According to such a configuration, the semipermeable membrane layer is suitably formed on the intermediate layer, and a composite hollow fiber membrane capable of more suitably performing separation by the semipermeable membrane layer can be obtained.

Further, in the composite hollow fiber membrane, it is preferable that the composite hollow fiber membrane is a forward osmosis membrane used in the forward osmosis method.

Since the composite hollow fiber membrane can suitably perform separation, using the semipermeable membrane layer, the composite hollow fiber membrane can be suitably used in the forward osmosis method. When the composite hollow fiber membrane is used in the forward osmosis method, it can exhibit, for example, excellent desalination performance.

Another aspect of the present invention is a method for manufacturing the composite hollow fiber membrane, the method including a step of preparing a first solution containing one of the polyfunctional amine compound and the polyfunctional acid halide compound, and a second solution containing the other of the polyfunctional amine compound and the polyfunctional acid halide compound and forming an interface with the first solution by contacting with the first solution; a first contact step of bringing the first solution into contact with at least one surface side of a hollow fiber member that is porous; and a second contact step of bringing the second solution into contact with the surface side of the hollow fiber member in contact with the first solution while shaking the hollow fiber member.

According to such a configuration, separation by a semipermeable membrane layer can be suitably performed, and further, a composite hollow fiber membrane having excellent durability can be suitably manufactured. This is considered due to the following.

In the composite hollow fiber membrane according to one aspect of the present invention, it is considered that the presence of the intermediate layer can suitably perform separation by a semipermeable membrane layer and further contributes greatly to improvement of durability. After the first contact step of bringing the first solution into contact with at least one surface side of the hollow fiber member that is porous, the second contact step of bringing the second solution into contact with the surface side of the hollow fiber member in contact with the first solution is performed while shaking the hollow fiber member. Then, it is considered that an interface between the first solution and the second solution is formed in the vicinity of the surface of the hollow fiber member in contact with the first solution, and a crosslinked polyamide formed of a polyfunctional amine compound and a polyfunctional acid halide compound are formed by polymerization at the interface. Then, it is considered that by shaking the hollow fiber member during the second contact step, the interface on which the crosslinked polyamide is polymerized is formed inside from the surface of the hollow fiber member in contact with the first solution. As a result, it is considered that the intermediate layer is formed from the surface of the hollow fiber member in contact with the first solution, and the portion where the crosslinked polyamide is not polymerized becomes the support layer. Further, it is considered that the crosslinked polyamide formed on the outside of the hollow fiber member from the surface in contact with the first solution becomes a semipermeable membrane layer. Thus, it is considered that a composite hollow fiber membrane including the intermediate layer, that is, a composite hollow fiber membrane according to one aspect of the present invention is manufactured. Therefore, it is considered that the separation by a semipermeable membrane layer can be suitably performed, and further, a composite hollow fiber membrane having excellent durability can be suitably manufactured.

Further, in the manufacturing method for the composite hollow fiber membrane, it is preferable that one of the first solution and the second solution is an aqueous solution of the polyfunctional amine compound, and the other of the first solution and the second solution is an organic solvent solution of the polyfunctional acid halide compound.

According to such a configuration, a composite hollow fiber membrane capable of performing the separation by a semipermeable membrane layer more suitably and having excellent durability can be manufactured. This is considered to be because the semipermeable membrane layer and the intermediate layer can be formed more suitably.

Further, in the manufacturing method for the composite hollow fiber membrane, it is preferable that the method further include, after the first contact step and before the second contact step, a step of removing the first solution existing on the surface of the hollow fiber member in contact with the first solution.

According to such a configuration, a composite hollow fiber membrane capable of performing the separation more suitably by a semipermeable membrane layer and having excellent durability can be manufactured. This is considered due to the following.

After the first contact step, the step of removing the first solution existing on the surface of the hollow fiber member in contact with the first solution is performed, and then the second contact step is performed. It is considered that the interface on which the crosslinked polyamide is polymerized is more suitably formed inside from the surface of the hollow fiber member in contact with the first solution. From this, it is considered that the intermediate layer is more suitably formed. Therefore, it is considered that a composite hollow fiber membrane that can more suitably perform the separation by a semipermeable membrane layer and has excellent durability can be more suitably manufactured.

Further, in the manufacturing method for a composite hollow fiber membrane, it is preferable that the second contact step is a step in which the hollow fiber member contacts only the second solution.

According to such a configuration, separation by a semipermeable membrane layer can be suitably performed, and further, a composite hollow fiber membrane having excellent durability can be more suitably manufactured. It is considered that this is because in the second contact step, when the hollow fiber member contacts, for example, a roller that conveys the hollow fiber member, a container that holds the second solution, or the like other than the second solution, the semipermeable membrane layer may not be suitably formed.

According to the present invention, it is possible to suitably perform separation by a semipermeable membrane layer. Further, the present invention can provide a composite hollow fiber membrane having excellent durability and a method for manufacturing the composite hollow fiber membrane.

Hereinafter, the present invention will be described more specifically by way of Examples, but the scope of the present invention is not limited thereto.

### EXAMPLES

### Example 1

(Preparation of Hollow Fiber Member)

As the hollow fiber member used when manufacturing a composite hollow fiber membrane, a hollow fiber membrane obtained by the following method was used.

A mixture of polyvinylidene fluoride (PVDF: Kynar741 manufactured by Arkema S.A.) as a resin that constitutes a hollow fiber membrane, γ-butyrolactone (GBL: GBL manufactured by Mitsubishi Chemical Corporation) as a solvent, polyvinyl pyrrolidone (PVP: Sokalan K-90P manufactured by BASF Japan Ltd.) as a hydrophilic resin, and polyethylene glycol (PEG-600 manufactured by Sanyo Chemical Industries, Ltd.) as an additive was first prepared at a mass ratio of 30:56:7:7. The mixture was dissolved in a dissolution tank at a constant temperature of 90° C. to obtain a membrane-forming stock solution.

The obtained membrane-forming stock solution of 90° C. was extruded into a hollow shape. At this time, γ-butyrolactone (GBL: GBL manufactured by Mitsubishi Chemical Corporation) and glycerin (purified glycerin manufactured by Kao Corporation) were mixed as an internal coagulating liquid at a constant temperature of 65° C. to have a mass ratio of 15:85. Then, the mixture was discharged simultaneously with the membrane-forming stock solution.

The membrane-forming stock solution extruded together with the internal coagulating liquid was immersed in water at 80° C. as an external coagulating liquid after a free running distance of 5 cm. Thereby, the membrane-forming stock solution was solidified to obtain a hollow fiber membrane.

Then, the obtained hollow fiber membrane was washed in water. Thereby, the solvent and the excess hydrophilic resin were extracted and removed from the hollow fiber membrane.

Then, the hollow fiber membrane was immersed in an aqueous solution containing 3% by mass of hydrogen peroxide. Thereby, the hydrophilic resin contained in the hollow fiber membrane was crosslinked. After that, the hollow fiber membrane was immersed in water, thereby to remove the hydrophilic resin that was insufficiently crosslinked, from the hollow fiber membrane. This indicates that the hydrophilic resin present in the hollow fiber membrane is a hydrophilic resin insolubilized by crosslinking. The hollow fiber membrane thus obtained was used as a hollow fiber member used when manufacturing a composite hollow fiber membrane as described above.

The hollow fiber member had a dense surface on the outer surface and had an inclined structure in which the inside pores gradually became large from the dense surface toward the inner surface. It was also found from observation using a scanning electron microscope (S-3000N manufactured by Hitachi, Ltd.) that the hollow fiber member had such an inclined structure.

(Preparation of Semipermeable Membrane Layer)

A semipermeable membrane layer was formed on the outer surface side of the hollow fiber member.

Specifically, the hollow fiber member was first immersed in a 50% by mass aqueous solution of ethanol for 20 minutes, and then washed with running water for 20 minutes. Thereby, a wet hollow fiber member was obtained.

After that, a wet hollow fiber member was prepared on the reel and the frame, and the hollow fiber member sent out from the reel and the frame was passed through a 2% by mass aqueous solution of m-phenylenediamine, which is an aromatic polyfunctional amine compound, for 2 minutes. Thereby, the aromatic polyfunctional amine aqueous solution was impregnated into the outer peripheral surface side of the hollow fiber member. Then, the hollow fiber member was passed through an air blow generated by an air knife to remove the excess aromatic polyfunctional amine aqueous solution that was not impregnated into the hollow fiber member.

Then, while shaking this hollow fiber member, it was passed through a 0.2% by mass hexane solution of trimesic acid trichloride, which is an aromatic polyfunctional acid chloride compound, for 2 minutes. While passing through the hexane solution, the hollow fiber member was not in contact with moving means such as a roller for transporting the hollow fiber member, a container holding the second solution, or the like. Then, the hollow fiber member was passed through a dryer at 120° C. and dried. These series of steps were carried out continuously so that the hollow fiber member was not interrupted in the middle. Thereby, a crosslinked polyamide in which m-phenylenediamine and trimesic acid trichloride were polymerized was formed inside and on the surface of the hollow fiber member. It is considered that this is because the interface between the m-phenylenediamine aqueous solution impregnated into the outer peripheral surface side of the hollow fiber member and the hexane solution of trimesic acid trichloride was formed inside the hollow fiber member by the shaking of the hollow fiber member. Then, it is considered that the interfacial polymerization of m-phenylenediamine and trimesic acid trichloride proceeded at the interface formed inside the hollow fiber member to form a crosslinked polyamide. The crosslinked polyamide formed on the surface of the hollow fiber member became the semipermeable membrane layer. The region where the formed crosslinked polyamide impregnated from the surface of the hollow fiber member toward the inside became the intermediate layer including the layer portion and the crosslinked polyamide. Further, in the hollow fiber member, a region where the crosslinked polyamide was not impregnated became the support layer.

(Pore Diameter of Layer Portion)

The average diameter of pores on the surface of the semipermeable membrane layer side of the layer portion provided on the intermediate layer was measured as follows.

The cut-off particle diameter of the hollow fiber member was first measured by the following method.

The blocking rates of at least two types of particles having different particle diameters (CATALOID SI-550, CATALOID SI-45P, CATALOID SI-80P, manufactured by JGC Catalysts and Chemicals Ltd.; polystyrene latex having a particle diameter of 0.1 μm, 0.2 μm, or 0.5 μm, manufactured by Dow Chemical Company) were measured, and based on the measured values, the value of S at which R was 90 was determined in the following approximate formula, and this was used as the cut-off particle diameter.

R=1001(1−m×exp(−a×log(S)))

In the above formula, a and m are constants determined by a hollow fiber membrane and are calculated based on the measured values of two or more blocking rates.

The cut-off particle diameter obtained by the above measurement method refers to an average diameter of pores on the dense surface (outer peripheral surface) side of the hollow fiber member and refers to an average diameter of pores on the surface of the semipermeable membrane layer side of the layer portion provided on the intermediate layer (pore diameter of the intermediate layer).

(Young's Modulus of Composite Hollow Fiber Membrane)

The Young's modulus of a composite hollow fiber membrane was calculated from the measurement results obtained by conducting a tensile property test of the composite hollow fiber membrane in accordance with the method described in JIS K7161-1.

(Thickness of Intermediate Layer)

The thickness of each of intermediate layers was measured as follows.

For any three points in the longitudinal direction of the composite hollow fiber membrane, a cross section perpendicular to the longitudinal direction was photographed at a magnification of 50000 using a scanning electron microscope (S-3000N manufactured by Hitachi, Ltd.), and the thickness of the intermediate layer at any two points in each cross section was measured. The thickness of the intermediate layer was determined to be a depth at which the crosslinked polyamide was impregnated from the surface of the hollow fiber member.

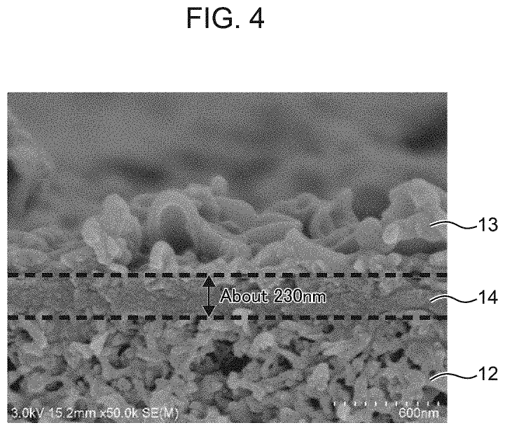

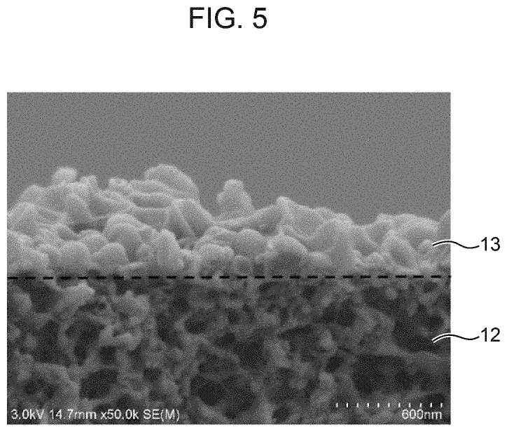

Note that FIG. 4 is a diagram showing a scanning electron micrograph of the vicinity of the outer peripheral surface in the cross section of the composite hollow fiber membrane of Example 1. Further, FIG. 5 is a diagram showing a scanning electron micrograph of the vicinity of the outer peripheral surface in the cross section of the composite hollow fiber membrane according to Comparative Example 1 described later. When the composite hollow fiber membrane according of Example 1 is observed with a scanning electron microscope, it can be understood that the semipermeable membrane layer 13, the intermediate layer 14, and the support layer 12 are provided in the composite hollow fiber membrane as shown in FIG. 4. Further, when the composite hollow fiber membrane of Comparative Example 1 is observed with a scanning electron microscope, it can be understood that the semipermeable membrane layer 13 and the support layer 12 are provided in the composite hollow fiber membrane as shown in FIG. 5, but the existence of the intermediate layer could not be confirmed. From this, the thickness of the intermediate layer of Comparative Example 1 is considered almost zero because the existence of the intermediate layer cannot be confirmed, and such thickness of the intermediate layer is indicated by the sign “−” in Table 1. Further, the thickness of the intermediate layers in the composite hollow fiber membranes according to the other Comparative Examples (Comparative Examples 2 to 5) are also shown as “−” in Table 1 because the existence of the intermediate layer cannot be confirmed as in the Comparative Example 1.

(Desalination Performance)

The obtained composite hollow fiber membrane was used in the forward osmosis (FO) method, and the water permeability and salt backflow rate were measured.

Specifically, a 0.5 M aqueous NaCl solution as a simulated draw solution (simulated DS) and ion exchanged water as a simulated feed solution (simulated FS) were placed with the obtained composite hollow fiber membrane interposed between the two solutions, and filtration was performed. At that time, the simulated FS flowed on the semipermeable membrane layer side of the composite hollow fiber membrane, and the simulated DS flowed on the support layer side of the composite hollow fiber membrane. The water permeation amount from the simulated FS to the simulated DS was calculated from each weight change of the simulated FS and the simulated DS. Then, the calculated water permeation amount was converted to water permeation amount per unit membrane area, per unit time, and per unit pressure to obtain a permeation rate (L/m²/hour: LMH) of water. The permeation rate was evaluated as water permeability. The change in a salt concentration of the simulated FS was measured. From the change in the salt concentration, a salt backflow rate (g/m²/hour: gMH) was obtained. Then, a desalination ratio (%) was calculated from the following formula. Note that the desalination performance can be evaluated from this desalination ratio.

R₅[1−ₛ/(J_{w}×C_{D})]×100

In the above formula, Rₛ indicates a desalination ratio (%), Jₛ indicates a salt backflow rate (gMH), J_{w} indicates a water permeation rate (LMH), and C_{D} indicates a salt concentration (g/L) of DS [In this case, the salt concentration (g/L) of DS is a NaCl concentration (0.5 M) of a simulated DS, which is about 29 g/L].

(Durability: Desalination Ratio after Contacting Composite Hollow Fiber Membranes with Each Other 10 Times).

After rubbing the obtained composite hollow fiber membranes with each other 10 times, a desalination ratio was measured in the same manner as the above desalination performance. The durability of the composite hollow fiber membrane can be evaluated from the degree of decrease in the measured desalination ratio with respect to the desalination ratio (the desalination ratio of the composite hollow fiber membrane before rubbing) when the desalination performance is evaluated.

These results are shown in Table 1 together with the manufacturing conditions.

### Example 2

A composite hollow fiber membrane was manufactured in the same manner as in Example 1 except that the following hollow fiber member was used as a hollow fiber member. Table shows the manufacturing conditions and evaluation results.

(Preparation of Porous Support in Form of Hollow Fiber)

The hollow fiber membrane obtained by the following method was used as a hollow fiber member.

A mixture of polysulfone (PSF: Ultrason 53010 manufactured by BASF Japan Ltd.) as a resin that constitutes a hollow fiber membrane (support layer), dimethylformamide (DMF: DMF manufactured by Mitsubishi Gas Chemical Company, Inc.) as a solvent, polyethylene glycol (PEG-600 manufactured by Sanyo Chemical Industries, Ltd.) as an additive, and polyvinyl pyrrolidone (PVP: Sokalan K-90P manufactured by BASF Japan Ltd.) as a hydrophilic resin was first prepared at a mass ratio of 20:48:30:2. The mixture was dissolved in a dissolution tank at a constant temperature of 25° C. to obtain a membrane-forming stock solution.

The obtained membrane-forming stock solution of 25° C. was extruded into a hollow shape. At this time, water of 25° C. was discharged simultaneously with the membrane-forming stock solution as an internal coagulating liquid.

The membrane-forming stock solution extruded together with the internal coagulating liquid was immersed in water at 60° C. as an external coagulating liquid after a free running distance of 5 cm. Thereby, the membrane-forming stock solution was solidified to obtain a hollow fiber membrane.

Then, the hollow fiber membrane was immersed in an aqueous solution containing 3% by mass of hydrogen peroxide. Thereby, the hydrophilic resin contained in the hollow fiber membrane was crosslinked. Then, the hollow fiber membrane was immersed in water. Thereby, the hydrophilic resin that was insufficiently crosslinked was removed from the hollow fiber membrane. This confirmed that the hydrophilic resin present in the hollow fiber membrane is a hydrophilic resin that has been insolubilized by crosslinking.

### Example 3

A composite hollow fiber membrane was manufactured in the same manner as in Example 1 except that the temperature of the membrane-forming stock solution extruded into a hollow fiber was changed from 90° C. to 120° C. and the temperature of the external coagulating liquid was changed from 80° C. to 90° C. Table 1 shows the manufacturing conditions and evaluation results.

### Example 4

A composite hollow fiber membrane was manufactured in the same manner as in Example 1 except that the temperature of the external coagulating liquid was changed from 80° C. to 70° C. Table 1 shows the manufacturing conditions and evaluation results.

### Comparative Example 1

A composite hollow fiber membrane was manufactured in the same manner as in Example 1 except that the hollow fiber member was not shaken when the hollow fiber member was passed through a 0.2% by mass hexane solution of trimesic acid trichloride, which is an aromatic polyfunctional acid chloride compound. Table 1 shows the manufacturing conditions and evaluation results.

### Comparative Example 2

A composite hollow fiber membrane was manufactured in the same manner as in Example 1 except that the temperature of the external coagulating liquid was changed from 80° C. to 60° C. Table 1 shows the manufacturing conditions and evaluation results.

### Comparative Example 3

A composite hollow fiber membrane was manufactured in the same manner as in Example 1 except that the following hollow fiber member was used as a hollow fiber member. Table 1 shows the manufacturing conditions and evaluation results.

(Preparation of Porous Support in Form of Hollow Fiber)

A mixed membrane-forming stock solution of polyvinylidene fluoride (hereinafter sometimes abbreviated as PVDF) (SOLEF 6010 manufactured by Solvay Solexis Inc.) as a vinylidene fluoride resin, γ-butyrolactone as a solvent, silica as inorganic particles (FINE SEAL X-45, manufactured by Tokuyama Co., Ltd.), and glycerin (purified glycerin manufactured by Kao Corporation) as a flocculant was prepared in at a weight ratio of 36:47:18:19. The composition of this mixed membrane-forming stock solution is shown in Table 1. The upper critical dissolution temperature of γ-butyrolactone and glycerin having the composition ratio was 40.6° C.

The mixed membrane-forming stock solution was heat-kneaded (temperature 150° C.) in a twin-screw kneading extruder, and the extruded strands were passed through a pelletizer to form chips. These tips were extruded using an extruder (150° C.) equipped with a nozzle having a double ring structure having an outer diameter of 1.6 mm and an inner diameter of 0.8 mm. At this time, tetraethylene glycol was injected into the hollow portion of the extruded product.

The extruded product extruded into the air from the spinneret was placed in a water bath (temperature 60° C.) containing an aqueous sodium sulfate solution of 20% by weight concentration after a free running distance of 3 cm and was passed through a water bath of about 100 cm, then solidified under cooling. Next, with most of the solvent, flocculant and inorganic particles remaining in the hollow fiber product, stretching treatment was performed in hot water at 90° C. so that the length was about 1.5 times the original length in the fiber direction. Then, the obtained hollow fiber product was heat-treated in running water at 95° C. for 180 minutes, and the solvent (γ-butyrolactone), the flocculant (glycerin), and the injection solution (tetraethylene glycol) were removed by extraction.

The hollow fiber product obtained in this manner was immersed in an aqueous solution of sodium hydroxide having a weight percent concentration of 5% at 40° C. for 120 minutes to extract and remove inorganic particles (silica), and then a hollow fiber membrane was obtained through a washing step.

### Comparative Example 4

A composite hollow fiber membrane was manufactured in the same manner as in Example 1 except that after passing the hollow fiber member through a 2% by mass aqueous solution of m-phenylenediamine, which is an aromatic polyfunctional amine compound, the hollow fiber member was passed through a 0.2% by mass hexane solution of trimesic acid trichloride, which is an aromatic polyfunctional acid chloride compound, without passing through the air blow generated by an air knife. Table 1 shows the manufacturing conditions and evaluation results.

### Comparative Example 5

A composite hollow fiber membrane was manufactured in the same manner as in Example 1 except that when the hollow fiber member was passed through a 0.2% by mass hexane solution of trimesic acid trichloride, which is an aromatic poly functional acid chloride compound, the hollow fiber member was in contact with a roller that conveys the hollow fiber member. Table 1 shows the manufacturing conditions and evaluation results.

TABLE 1

| | | Example | | | | Comparative Example | | | | |
|---|---|---|---|---|---|---|---|---|---|---|
| | | 1 | 2 | 3 | 4 | 1 | 2 | 3 | 4 | 5 |
| Manufacturing | Material of hollow | PVDF | PSF | PVDF | PVDF | PVDF | PVDF | PVDF | PVDF | PVDF |
| conditions | fiber member | | | | | | | | | |
| | Shaking | Yes | Yes | Yes | Yes | No | Yes | Yes | Yes | Yes |
| | Air blow | Yes | Yes | Yes | Yes | Yes | Yes | Yes | No | Yes |
| | Contact with roller | No | No | No | No | No | No | No | No | Yes |
| Thickness of intermediate layer (nm) | | 230 | 500 | 2800 | 150 | — | — | — | — | — |
| Pore diameter of intermediate | | 0.019 | 0.023 | 0.1 | 0.016 | 0.019 | 0.009 | 2.1 | 0.019 | 0.019 |
| layer (μm) | | | | | | | | | | |
| Young's modulus (N/mm²) | | 150 | 200 | 150 | 150 | 150 | 80 | 350 | 150 | 150 |
| Evaluation | Desalination ratio (%) | 95 | 90 | 94 | 95 | 95 | 15 | 10 | 90 | 42 |
| | Desalination ratio (%) | 94 | 90 | 92 | 94 | 63 | 3 | 5 | 37 | 7 |
| | after contact between | | | | | | | | | |
| | membranes | | | | | | | | | |

As can be seen from Table 1, in the case of a composite hollow fiber membrane (composite hollow fiber membranes according to Examples 1 to 4) having a semipermeable membrane layer containing a crosslinked polyimide formed of a polyfunctional amine compound and a polyfunctional acid halide compound, a support layer that has a hollow fiber shape and is porous, and an intermediate layer which is interposed between the semipermeable membrane layer and the support layer and in which the crosslinked polyimide is impregnated into the layer portion member of the same material as the support layer, the composite hollow fiber membrane had excellent desalination performance as compared with the case where the intermediate layer was not provided (composite hollow fiber membranes according to Comparative Examples 1 to 5), and further, such a membrane was excellent in durability such as being able to suppress a decrease in desalination performance when the composite hollow fiber membranes were brought into contact with each other.

On the other hand, when the hollow fiber member was passed through the second solution of a 0.2% by mass hexane solution of trimesic acid trichloride, which is an aromatic polyfunctional acid chloride compound, and the hollow fiber member was not shaken (Comparative Example 1), the intermediate layer was not suitably formed. In the case of the composite hollow fiber membrane according to Comparative Example 1, the desalination performance was excellent, but the desalination performance after the composite hollow fiber membranes were brought into contact with each other 10 times was inferior to the hollow fiber membranes according to Examples 1 to 4. From these facts, it is found that in the composite hollow fiber membrane according to Comparative Example 1, a semipermeable membrane layer was suitably formed, but as described above, an intermediate layer was not suitably formed.

When the pore diameter of the hollow fiber member, that is, the pore diameter of the intermediate layer was too small (Comparative Example 2) or too large (Comparative Example 3), the intermediate layer was not suitably formed. In the case of the composite hollow fiber membrane according to Comparative Example 2, both the desalination performance and even the desalination performance after the composite hollow fiber membranes were brought into contact with each other 10 times were inferior in comparison with those of the composite hollow fiber membranes according to Examples 1 to 4. From these facts, it can be understood that in the composite hollow fiber membrane according to Comparative Example 1, not only the intermediate layer was not suitably formed as described above, but also the semipermeable membrane layer was not suitably formed.

When the hollow fiber member was passed through a first solution of a 2% by mass aqueous solution of m-phenylenediamine, which is an aromatic polyfunctional amine compound, and then was not passed through the air blow generated by an air knife (Comparative Example 4), the intermediate layer was not suitably formed. In the case of the composite hollow fiber membrane according to Comparative Example 4, the desalination performance was excellent to some extent, but the desalination performance after the composite hollow fiber membranes were brought into contact with each other 10 times was inferior to the composite hollow fiber membranes according to Examples 1 to 4. From these facts, it can be understood that in the composite hollow fiber membrane according to Comparative Example 4, the semipermeable membrane layer was suitably formed to some extent, but the intermediate layer was not suitably formed as described above.

When the hollow fiber member was passed through the second solution and was brought into contact with a roller that conveys the hollow fiber member (Comparative Example 5), the intermediate layer was not suitably formed. In the case of the composite hollow fiber membrane according to Comparative Example 5, both the desalination performance and even the desalination performance after the composite hollow fiber membranes were brought into contact with each other 10 times were inferior to those of the composite hollow fiber membranes according to Examples 1 to 4. From these facts, it can be understood that in the composite hollow fiber membrane according to Comparative Example 5, not only the intermediate layer was not suitably formed, but also the semipermeable membrane layer was not suitably formed as described above.

The present application is based on Japanese Patent Application No. 2019-036304 filed on Feb. 28, 2019, the contents of which are incorporated herein.

It is to be understood that although the present invention has been described appropriately and sufficiently through the embodiments above to express the present invention, it is easy for a person skilled in the art to change and/or improve the above-mentioned embodiments. Therefore, unless a modification or improvement made by a person skilled in the art is not at a level that departs from the scope of the claims set forth in the claims, such a modification or improvement shall be construed as being included in the scope of the claims.

### INDUSTRIAL APPLICABILITY

The present invention provides a composite hollow fiber membrane capable of suitably performing separation by a semipermeable membrane layer and further having excellent durability, and a method for manufacturing the composite hollow fiber membrane.

1. A composite hollow fiber membrane, comprising:
a semipermeable membrane layer;
a support layer that has a hollow fiber shape and is porous; and
an intermediate layer interposed between the semipermeable membrane layer and the support layer,
wherein the semipermeable membrane layer comprises a crosslinked polyamide formed of a polyfunctional amine compound and a polyfunctional acid halide compound, and
the intermediate layer comprises a layer portion made of a same material as the support layer, and the crosslinked polyamide impregnating the layer portion.

2. The composite hollow fiber membrane of claim 1, wherein the intermediate layer has a thickness of 20 to 5000 nm.

3. The composite hollow fiber membrane of claim 1, which has a Young's modulus of 50 to 300 N/mm².

4. The composite hollow fiber membrane of claim 1, wherein the intermediate layer contacts an outer peripheral surface of the support layer, and the semipermeable membrane layer contacts an outer peripheral surface of the intermediate layer.

5. The composite hollow fiber membrane of claim 1, wherein pores on a surface of the semipermeable membrane layer side of the layer portion have an average diameter of 0.01 to 2 μm.

6. The composite hollow fiber membrane of claim 1, which is a forward osmosis membrane suitable for a forward osmosis method.

7. A method for manufacturing the composite hollow fiber membrane of claim 1, the method comprising:
preparing a first solution comprising one of the polyfunctional amine compound and the polyfunctional acid halide compound, and a second solution comprising the other of the polyfunctional amine compound and the polyfunctional acid halide compound and forming an interface with the first solution by contacting with the first solution;
contacting the first solution with at least one surface side of a hollow fiber member that is porous; and
contacting the second solution with the at least one surface side of the hollow fiber member contacting the first solution while shaking the hollow fiber member.

8. The method of claim 7, wherein
one of the first solution and the second solution is an aqueous solution of the polyfunctional amine compound, and
the other of the first solution and the second solution is an organic solvent solution of the polyfunctional acid halide compound.

9. The method of claim 7, further comprising, after the contacting of the first solution and before the contacting of the second solution, removing the first solution existing on the at least one surface of the hollow fiber member contacting the first solution.

10. The method of claim 7, wherein, in the contacting of the second solution, the hollow fiber member contacts only the second solution.

11. The composite hollow fiber membrane of claim 2, which has a Young's modulus of 50 to 300 N/mm².

12. The composite hollow fiber membrane of claim 2, wherein the intermediate layer contacts an outer peripheral surface of the support layer, and the semipermeable membrane layer contacts an outer peripheral surface of the intermediate layer.

13. The composite hollow fiber membrane of claim 3, wherein the intermediate layer contacts an outer peripheral surface of the support layer, and the semipermeable membrane layer contacts an outer peripheral surface of the intermediate layer.

14. The composite hollow fiber membrane of claim 2, wherein pores on a surface of the semipermeable membrane layer side of the layer portion have an average diameter of 0.01 to 2 μm.

15. The composite hollow fiber membrane of claim 3, wherein pores on a surface of the semipermeable membrane layer side of the layer portion have an average diameter of 0.01 to 2 μm.

16. The composite hollow fiber membrane of claim 4, wherein pores on a surface of the semipermeable membrane layer side of the layer portion have an average diameter of 0.01 to 2 μm.

17. The composite hollow fiber membrane of claim 2, which is a forward osmosis membrane suitable for a forward osmosis method.

18. The composite hollow fiber membrane of claim 3, which is a forward osmosis membrane suitable for a forward osmosis method.

19. The composite hollow fiber membrane of claim 4, which is a forward osmosis membrane suitable for a forward osmosis method.

20. The composite hollow fiber membrane of claim 5, which is a forward osmosis membrane suitable for a forward osmosis method.
